(19) United States
(12) Patent Application Publication
(10) Pub. No.: US 2026/0080825 A1
(43) Pub. Date: Mar. 19, 2026

(54) PIXEL, DISPLAY DEVICE HAVING THE SAME AND ELECTRONIC DEVICE INCLUDING DISPLAY DEVICE

(71) Applicant: Samsung Display Co., Ltd., Yongin-Si (KR)

(72) Inventors: HANBIT KIM, Yongin-si (KR); THANH TIEN NGUYEN, Yongin-si (KR); DOO-NA KIM, Yongin-si (KR); JIYEONG SHIN, Yongin-si (KR); DOKYEONG LEE, Yongin-si (KR); SANGGUN CHOI, Yongin-si (KR)

(21) Appl. No.: 19/180,567

(22) Filed: Apr. 16, 2025

(30) Foreign Application Priority Data
Sep. 13, 2024 (KR) 10-2024-0125812

(51) Int. Cl. G09G 3/3233

(52) U.S. Cl. CPC G09G 3/3233; G09G 2300/0819; G09G 2300/0842; G09G 2310/08

(57) ABSTRACT

A pixel includes a first transistor for controlling a driving current for light-emission of a light-emitting element, a second transistor for controlling a signal applied to a gate terminal of the first transistor by being turned on and off by a scan signal, and a storage capacitor, wherein either a data signal or a first driving voltage is selectively applied.

### CROSS-REFERENCE TO RELATED APPLICATION

This application is based on and claims priority under 35 USC § 119 to Korean Patent Application No. 10-2024-0125812, filed on Sep. 13, 2024, in the Korean Intellectual Property Office, the disclosure of which is incorporated by reference herein in its entirety.

### BACKGROUND

### 1. Field

The present disclosure relates to a pixel, a display device having the same, and electronic device including the display device.

### 2. Description of the Related Art

Pixels emit light based on data voltages and each include a transistor (e.g. thin film transistor (TFT)) that controls the operation of the each pixel. Display devices may display images in a sequential emission method in which pixels emit light sequentially in rows, or in a simultaneous emission method in which all pixels emit light simultaneously after data writing is completed sequentially.

Meanwhile, as the demand for high resolution and definition has increased in the display device technology field, the integration of circuits has become important, and the design of small-sized pixels and/or sophisticated micro-processing technology may be required for the integration of circuits.

### SUMMARY

Some embodiments according to the present disclosure provide a pixel, a display device having the same and electronic device including the display device. The problems to be solved by the present disclosure are not limited to the problems mentioned above, and other problems and advantages of the present disclosure that are not mentioned may be understood by the following description and will be more clearly understood by the embodiments of the present disclosure. In addition, it will be appreciated that the problems and advantages to be solved by the present disclosure may be realized by the means and combinations thereof indicated in the claims.

An embodiment of the present disclosure provides a pixel including a first transistor a first terminal of which is connected to a first driving voltage line and a second terminal of which is connected to a second driving voltage line via a light-emitting element, a second transistor connected between the second terminal of the first transistor and a gate terminal of the first transistor, and a storage capacitor, wherein one of a data signal and a first driving voltage is selectively supplied from the first driving voltage line.

In an embodiment, a first terminal of the storage capacitor may be connected to a gate terminal of the first transistor, and a second terminal of the storage capacitor may be connected to an initialization voltage line.

In an embodiment, an initialization voltage is supplied from the initialization voltage line and the initialization voltage swings between a high level voltage and a low level voltage

In an embodiment, a cathode of the light-emitting element may be connected to the second driving voltage line.

In an embodiment, a second driving voltage is supplied from the second driving voltage line and the second driving voltage swings between a high level voltage and a low level voltage

In an embodiment, in a data writing period, the data signal is applied to the first terminal of the first transistor.

In an embodiment, the first driving voltage may be applied to the first terminal of the first transistor in a period other than the data writing period.

Another embodiment of the present disclosure may provide a display device, comprising a pixel unit including a plurality of pixels, each of the plurality of pixels is connected to a corresponding scan line among a plurality of scan lines and a corresponding data line among a plurality of data lines, a scan driving unit supplying a scan signal to each of the plurality of pixels through the plurality of scan lines, and a data driving unit selectively supplying one of a data signal and a first driving voltage to each of the plurality of pixels through the plurality of data lines, wherein each of the plurality of pixels includes a first transistor a first terminal of which is connected to a first driving voltage line and a second terminal of which is connected to a second driving voltage line via a light-emitting element, a second transistor connected between the second terminal of the first transistor and a gate terminal of the first transistor, and a storage capacitor. One of a data signal and a first driving voltage is selectively supplied from the first driving voltage line.

In an embodiment, the device further includes a power supply unit that supplies an initialization voltage to each of the plurality of pixels through a plurality of initialization voltage lines, wherein a first terminal of the storage capacitor may be connected to a gate terminal of the first transistor, and a second terminal of the storage capacitor may be connected to a corresponding initialization voltage line.

In an embodiment, the initialization voltage may swing a high level voltage and a low level voltage.

In an embodiment, the device further includes a power supply unit that supplies an initialization voltage to each of the plurality of pixels through a plurality of second driving voltage lines, wherein a cathode of the light-emitting element may be connected to a corresponding second driving voltage line.

In an embodiment, the second driving voltage may swing between a high level voltage and a low level voltage.

In an embodiment, each of the plurality of data lines is connected to a first terminal of a first transistor of each of the plurality of pixels, and the data driving unit may supply the data signal in a data writing period.

In an embodiment, the data driving unit may supply the first driving voltage in a period other than the data writing period.

Another embodiment of the present disclosure may provide an electronic device, including a processor and a display device receiving a clock signal and image data from the processor. The electronic device may include a first transistor a first terminal of which is connected to a first driving voltage line and a second terminal of which is connected to a second driving voltage line via a light-emitting element, a second transistor connected between the second terminal of the first transistor and a gate terminal of the first transistor, and a storage capacitor. One of a data signal and a first driving voltage may be selectively supplied from the first driving voltage line.

In an embodiment, a first terminal of the storage capacitor may be connected to the gate terminal of the first transistor and a second terminal of the storage capacitor is connected to an initialization voltage line.

In an embodiment, an initialization voltage may be supplied from the initialization voltage line and the initialization voltage swings between a high level voltage and a low level voltage.

In an embodiment, a cathode of the light-emitting element may be connected to the second driving voltage line supplying a second driving voltage which swings between a high level voltage and a low level voltage.

In an embodiment, the data signal may be applied to the first terminal of the first transistor in a data writing period.

In an embodiment, the first driving voltage may be applied to the first terminal of the first transistor in a period other than the data writing period.

Other aspects, features and advantages other than those described above will become apparent from the following drawings, claims and detailed description of the invention.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a display device according to an embodiment of the present disclosure;

FIG. 2 is a circuit diagram showing the structure of a pixel PX according to an embodiment of the present disclosure;

FIG. 3 is a timing diagram of signals for driving the pixel PX of FIG. 2;

FIG. 4 is a circuit diagram for explaining the operation of elements of the pixel PX of FIG. 2 in an initialization period;

FIG. 5 is a circuit diagram for explaining the operation of the elements of the pixel PX of FIG. 2 in a data writing period;

FIG. 6 is a circuit diagram for explaining the operation of the elements of the pixel PX of FIG. 2 in an on-bias period;

FIG. 7 is a circuit diagram for explaining the operation of the elements of the pixel PX of FIG. 2 in a light-emitting period;

FIG. 8 is a timing diagram of signals for driving a display device according to an embodiment of the present disclosure; and

FIG. 9 is a circuit diagram for explaining a method of driving a sub-pixel (sub-PX) according to an embodiment of the present disclosure.

FIG. 10 is a block diagram showing an electronic apparatus according to an embodiment.

### DETAILED DESCRIPTION

The present disclosure may be modified in various ways and has various embodiments. Specific embodiments are illustrated in the drawings and described in detail in the detailed description. The effects and features of the present disclosure and the method for achieving them will become clear with reference to the embodiments described in detail below together with the drawings. However, the present disclosure is not limited to the embodiments disclosed below and may be implemented in various forms.

In the embodiments below, the terms first, second, or the like are not used in a limiting sense but are used for the purpose of distinguishing one component from another.

In the embodiments below, singular expressions include plural expressions unless the context clearly indicates otherwise.

In the embodiments below, terms such as “include” or “have” mean that a feature or component described in the specification is present, and do not exclude in advance the possibility that one or more other features or components may be added.

In the embodiments below, when it is said that a part such as a unit, region, or component is located above or on another part, it includes not only the case where it is directly above the other part, but also the case where another unit, region, or component is interposed in between.

In the embodiments below, terms such as connect or combine do not necessarily imply a direct and/or fixed connection or combination of two members, unless the context clearly indicates otherwise, and do not exclude the presence of another member between the two members.

In the drawings, components may be exaggerated or reduced in size for convenience of explanation. In some embodiments, the size and/or thickness of each component shown in the drawings are arbitrarily shown for convenience of explanation, and therefore the present disclosure is not necessarily limited to what is shown.

Hereinafter, embodiments of the present disclosure will be described in detail with reference to the attached drawings. When describing with reference to the drawings, identical or corresponding components are given the same drawing reference numerals and redundant descriptions thereof will be omitted.

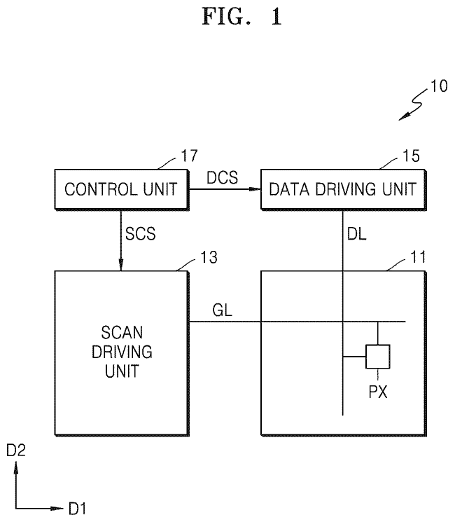

FIG. 1 is a block diagram illustrating a display device 10 according to an embodiment of the present disclosure.

The display device 10 according to embodiments of the present disclosure may be implemented as an electronic device such as a smart phone, a mobile phone, a smart watch, a navigation device, a game console, a TV, a head unit for a vehicle, a notebook computer, a laptop computer, a tablet computer, a personal media player (PMP), personal digital assistance (PDA), a wearable device, or the like. The electronic device may include a processor, for example, an application processor, connected to the display device 10 and supplying clock signals and image data to the display device 10.

Referring to FIG. 1, the display device 10 of the present disclosure may include a pixel unit 11, a scan driving unit 13, a data driving unit 15, and a control unit 17.

The pixel unit 11 may be provided with a plurality of scan lines (or gate lines GL), a plurality of data lines DL, and a plurality of pixels PX connected to the plurality of scan lines and the plurality of data lines DL.

Multiple pixels PX may be arranged in various forms, such as a stripe arrangement, a pentile arrangement (diamond arrangement), and a mosaic arrangement, to display an image. The pixel unit 11 may be placed in a display area of a substrate. Each pixel PX may include a light-emitting element, and the light-emitting element may be connected to a pixel circuit. In some embodiments, the light-emitting element may be an organic light-emitting diode (OLED).

Each pixel PX may emit light of, for example, red, green, blue or white through a light-emitting element. Each pixel PX may be connected to at least one scan line GL among a plurality of scan lines GL and a corresponding data line DL among a plurality of data lines DL.

The scan lines GL may each extend in a first direction D1 (e.g., x direction or row direction) and be connected to pixels PX located in the same row. The scan lines GL may each transmit scan signals to the pixels PX in the same row. The data lines DL may each extend in a second direction D2 (e.g. in the y direction or the column direction) and be connected to pixels PX located in the same column. The data lines DL may each transmit data signals DATA to the pixels PX in the same column.

The scan driving unit 13 is connected to a plurality of scan lines GL, generates scan signals in response to a control signal (GCS) from the control unit 17, and may sequentially supply the scan signals to the scan lines GL. A scan line GL may be connected to a gate of a transistor included in a pixel PX. A scan signal may be a gate control signal that controls the turn-on and turn-off of a transistor whose gate is connected to a scan line GL. The scan signal may be a square wave signal including an on-voltage that may turn on the transistor and an off-voltage that may turn off the transistor. In an embodiment, the on voltage may be a high level voltage (a first level voltage) or a low level voltage (a second level voltage). The period in which the on voltage of the scan signal is maintained (hereinafter referred to as a “on-voltage period”) and the period in which the off voltage is maintained (hereinafter referred to as a “off-voltage period”) may be determined depending on the function of the transistor that receives the scan signal within the pixel PX.

The data driving unit 15 is connected to a plurality of data lines DL and may supply data signals to the data lines DL in response to a control signal (DCS) from the control unit 17. The data signals supplied from the data lines DL may be supplied to pixels PX connected to the scan line which is activated.

Although not shown in FIG. 1, the display device 10 may include a power supply unit. The power supply unit may generate voltages necessary for driving pixels PX based on the control signal (DCS) from the control unit 17. In some embodiments, the power supply unit may supply a first driving voltage ELVDD and a second driving voltage ELVSS. In some embodiments, the power supply unit may supply an initialization voltage VINT for initializing a transistor within a pixel PX. The power supply unit may supply the first driving voltage ELVDD, the second driving voltage ELVSS, and the initialization voltage VINT through each of a first driving voltage line, a second driving voltage line, and an initialization voltage line. Meanwhile, as will be described later, the first driving voltage ELVDD and the data signal DATA may be selectively applied to the pixel PX or the pixel circuit according to the embodiments of the present disclosure, and depending on the implementation method, the first driving voltage line may not be provided.

The control unit 17 may generate control signals GCS and DCS based on signals input from the outside and supply them to the scan driving unit 13 and the data driving unit 15. The control signal GCS supplied to the scan driving unit 13 may include a plurality of clock signals and scan start signals. The control signal DCS supplied to the data driving unit 15 may include a source start signal and clock signals.

The display device 10 includes a display panel, and the display panel may include a substrate. The display device 10 may include a display area that displays an image and a peripheral area (or non-display area) outside the display area surrounding the display area. A pixel unit 11 is placed in the display area of the substrate, and a scan driving unit 13, a data driving unit 15, a power supply unit (not shown), or the like may be placed in the peripheral area.

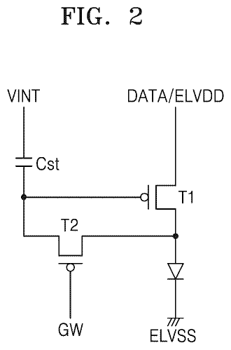

FIG. 2 is a circuit diagram showing the structure of a pixel PX according to an embodiment of the present disclosure.

Referring to FIG. 2, a pixel PX according to an embodiment of the present disclosure may include two transistors T1 and T2, one capacitor Cst and one light-emitting element LED. A pixel PX according to an embodiment of the present disclosure may include a first transistor T1 for controlling a driving current for light-emission of the light-emitting element LED, a second transistor T2 that is turned on and off in response to a scan signal and controls a signal applied to a gate terminal of the first transistor, and a storage capacitor Cst.

One of a data signal DATA and a first driving voltage ELVDD may be selectively applied to a pixel PX of the present disclosure. Additionally, the pixel PX of the present disclosure may be applied with an initialization voltage VINT and a second driving voltage ELVSS whose amount of voltages change. That is, in the present disclosure, each of the initialization voltage VINT and the second driving voltage ELVSS may swing between a high level voltage and a low level voltage, rather than have a constant voltage.

The pixel PX of the present disclosure operated by signals having these characteristics may be implemented with a smaller number of elements than a conventional pixel PX, and thus, a display device or display panel including the pixel PX of the present disclosure may have a high degree of integration.

Referring to FIG. 2, a source terminal of the first transistor T1 may be connected to a data/first driving voltage DATA/ELVDD line. A data signal DATA or a first driving voltage ELVDD may be supplied from the data/first driving voltage DATA/ELVDD line to the pixel. An embodiment of the present disclosure for generating a data signal DATA or a first driving voltage ELVDD will be described later.

Referring to FIG. 2, a drain terminal of the first transistor T1 may be connected to an anode of the light-emitting element LED. Additionally, the source terminal of the second transistor T2 may be connected to the drain terminal of the first transistor T1 and the anode of the light-emitting element LED. Referring to FIG. 2, a cathode of the light-emitting element may be connected to a second driving voltage line. A second driving voltage ELVSS may be supplied from the second driving voltage line.

Referring to FIG. 2, the drain terminal of the second transistor T2 may be connected to a gate terminal of the first transistor T1. Additionally, a first terminal of a storage capacitor Cst may be connected to the gate terminal of the first transistor T1 and the drain terminal of the second transistor T2. Referring to FIG. 2, a second terminal of the storage capacitor Cst may be connected to the initialization voltage line. An initialization voltage VINT may be supplied from the initialization voltage line.

Referring to FIG. 2, the gate terminal of the second transistor T2 may be connected to a scan line. A scan signal GW may be applied through the scan line.

The first transistor T1 of the pixel PX of the present disclosure may be turned on or off in response to a signal applied to the gate terminal of the first transistor T1, or the voltage of the first terminal of the storage capacitor Cst or the voltage of the drain terminal of the second transistor T2.

The second transistor T2 of the pixel PX of the present disclosure may be turned on or off in response to a signal applied to the gate terminal of the second transistor T2, or a scan signal GW.

As described above, in the pixel PX of the present disclosure, one of a data signal DATA and a first driving voltage ELVDD may be selectively applied to one terminal, or a source terminal of a driving transistor (the first transistor T1).

In an embodiment, the data signal DATA and the first driving voltage ELVDD are generated as separate signals, and, for example, based on the control of the control unit 17 of FIG. 1, the data signal DATA or the first driving voltage ELVDD may be applied to the pixel PX. In some embodiments, the data signal DATA may be generated and applied by the data driving unit 15, and the first driving voltage ELVDD may be generated and applied by the power supply unit.

In an embodiment, the data signal DATA and the first driving voltage ELVDD may be a single signal. In some embodiments, the data signal DATA and the first driving voltage ELVDD are the single signal generated and supplied from the data driving unit 15 and may have different names based on the roles thereof. In an embodiment, the first driving voltage ELVDD may be a sustain voltage (Vsus). In this case, a sustain voltage (Vsus) as a first driving voltage ELVDD may be applied to the data/first driving voltage DATA/ELVDD line in a period other than a data writing period P2 described later, and a data signal DATA for grayscale expression may be applied to the data/first driving voltage DATA/ELVDD line in the data writing period P2.

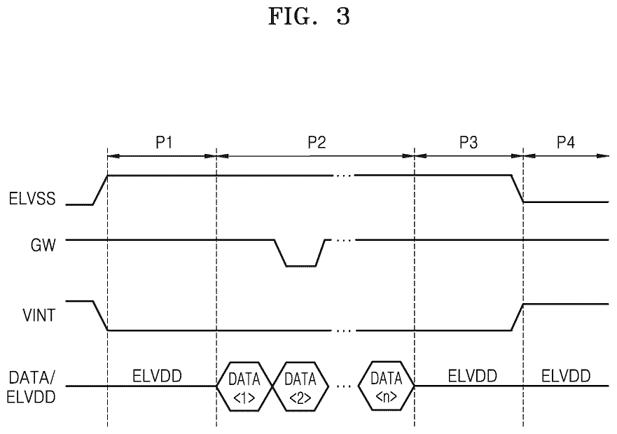

FIG. 3 is a timing diagram of signals for driving the pixel PX of FIG. 2.

Referring to FIG. 3, changes in the signals applied to the pixel PX of FIG. 2, namely the second driving voltage ELVSS, the scan signal GW, the initialization signal VINT, and the data signal DATA or the first driving voltage ELVDD, in one unit period (e.g. a single frame period) are illustrated.

Referring to FIG. 3, one unit period may largely include an initialization period P1, a data writing period P2, an on-bias period P3, and a light-emitting period P4.

The initialization period P1 may be a period for initializing the gate terminal of the driving transistor of the pixel PX (e.g. the first transistor T1 of FIG. 2). The data writing period P2 may be a period in which a data signal DATA is applied to the gate terminal of the driving transistor of the pixel PX and Vth compensation is performed. The on bias period P3 may be a period in which a bias voltage is applied to the driving transistor of the pixel PX to apply a driving current to the light-emitting element LED. The light-emitting period P4 may be a period in which the current flowing through the driving transistor of the pixel PX is applied to the light-emitting element LED, causing the light-emitting element to emit light or not emit light.

Meanwhile, referring to FIG. 3, it will be apparent to those skilled in the art that the timing diagram of FIG. 3 relates to a pixel (PX) connected to a second row, for example, a second scan line GL, in a display device or a display panel. This may be seen through the fact that the scan signal GW switches to an active level, for example, a low level, when a data signal DATA<2>corresponding to the second row of data signals DATA for grayscale expression occurs.

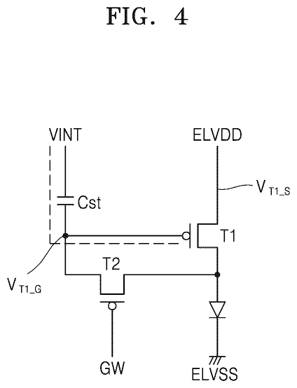

Hereinafter, with reference to FIGS. 4 to 7, the operation of each period of a pixel PX according to an embodiment of the present disclosure illustrated in FIG. 2 will be described. In FIGS. 4 to 7, periods that are electrically connected and through which signals are transmitted are indicated by dotted lines.

FIG. 4 is a circuit diagram for explaining the operation of the elements of the pixel PX of FIG. 2 in the initialization period.

Referring to FIG. 3, in the initialization period P1, the second driving voltage ELVSS applied to the cathode of the light-emitting element has a high level voltage, the scan signal GW applied to the gate terminal of the second transistor T2 has a high level voltage, the initialization voltage VINT applied to the second terminal of the storage capacitor Cst has a low level voltage, and the voltage applied to the source terminal of the first transistor T1 has a first driving voltage ELVDD. Here, the first driving voltage ELVDD may be the sustain voltage (Vsus).

Based on these signals, referring to FIG. 4, the second transistor T2 may be turned off, and a gate terminal voltage V_{T1_G} of the first transistor T1 may have an initialization voltage of a low level voltage. Accordingly, the voltage of the gate terminal of the first transistor T1 may be initialized to a value corresponding to the low level voltage of the initialization voltage VINT. Meanwhile, the voltage of the cathode of the light-emitting element may have a second driving voltage ELVSS of a high level voltage.

In summary, in order to write data of a new frame on a pixel PX, an initialization voltage of a low level voltage may be applied to the gate terminal of the first transistor T1 in the initialization period P1.

Meanwhile, a high level of the second driving voltage ELVSS may be appropriately set based on the range of values of the data signal for grayscale expression. In some embodiments, the high level of the second driving voltage ELVSS may be set to a value at which the light-emitting element does not emit light within the range of values of the data signal for grayscale expression.

In addition, a low level of the initialization voltage VINT may be set to an appropriate value for initializing the driving transistor (e.g. the first transistor T1 of FIG. 2).

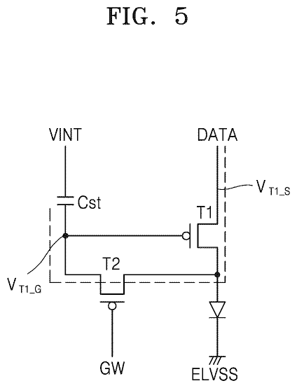

FIG. 5 is a circuit diagram for explaining the operation of the elements of the pixel PX of FIG. 2 in the data writing period.

Referring to FIG. 3, in the data writing period P2, the second driving voltage ELVSS applied to the cathode of the light-emitting element has a high level voltage, the scan signal GW applied to the gate terminal of the second transistor T2 has a low level voltage when the second scan line GL has an active level, the initialization voltage VINT applied to the second terminal of the storage capacitor Cst has a low level voltage, and the voltage applied to the data/first driving voltage DATA/ELVDD line which is connected to a source terminal of the first transistor T1 has a voltage corresponding to the data signal.

As mentioned above, the timing diagram of FIG. 3 may relate to the second row in a display device or display panel. In the data writing period P2 of FIG. 3, the period in which the scan signal (GW) has a low level voltage may be formed to receive only a specific data signal, that is, a data signal corresponding to the second row, among the data signals corresponding to n rows that may be applied to the data writing period P2 of FIG. 3.

Based on these signals, referring to FIG. 5, the second transistor T2 may be turned on in a period where the scan signal GW has a low level voltage. A voltage corresponding to a data signal (e.g. Data<2>of FIG. 3) may be applied to the source terminal of the first transistor T1. That is, a source terminal voltage V_{T1_S} of the first transistor T1 may be Vdata. Accordingly, a drain terminal voltage of the first transistor T1 (or a source terminal voltage of the second transistor T2) may be Vdata-Vth. Additionally, as described above, due to the second transistor T2 being turned on, the drain terminal voltage of the second transistor T2, or the gate terminal voltage V_{T1_G} of the first transistor T1, may also be Vdata-Vth. Vth compensation may be performed by the relationship between the voltages applied to each of these nodes.

Meanwhile, the voltage of the cathode of the light-emitting element may have a high level second driving voltage ELVSS not to emit light from the light emitting element LED.

Meanwhile, a person skilled in the art will understand that Vdata-Vth is a value applied to the gate terminal of the first transistor T1 to turn-on the first transistor T1.

In summary, when a voltage based on a data signal is applied to the gate terminal of the first transistor T1 in the data writing period P2, data of a new frame is written to the pixel PX, and Vth compensation may be performed.

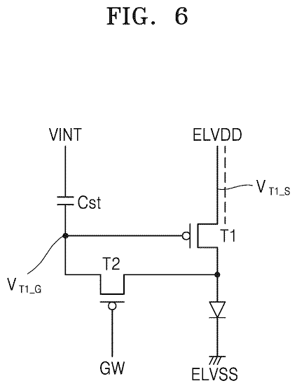

FIG. 6 is a circuit diagram for explaining the operation of the elements of the pixel PX of FIG. 2 in the on-bias period.

Referring to FIG. 3, during the on-bias period P3, the second driving voltage ELVSS applied to the cathode of the light-emitting element has a high-level voltage, the scan signal GW applied to the gate terminal of the second transistor T2 has a high-level voltage, the initialization voltage VINT applied to the second terminal of the storage capacitor Cst has a low-level voltage, and the voltage applied to the data/first driving voltage DATA/ELVDD line which is connected to a source terminal of the first transistor T1 has the first driving voltage ELVDD.

Based on these signals, referring to FIG. 6, the second transistor T2 may be turned off, and the gate terminal voltage V_{T1} of the first transistor T1 may be Vdata-Vth, the same as the data writing period P2. Meanwhile, since the first driving voltage ELVDD is applied to the source terminal of the first transistor T1, the source terminal voltage V_{T1_S} of the first transistor T1 may have a first driving voltage ELVDD. Additionally, the voltage of the cathode of the light-emitting element may have the high level second driving voltage ELVSS.

In summary, to emit light from the light-emitting element, a first driving voltage ELVDD may be applied to the source terminal of the first transistor T1 in the on-bias period P3.

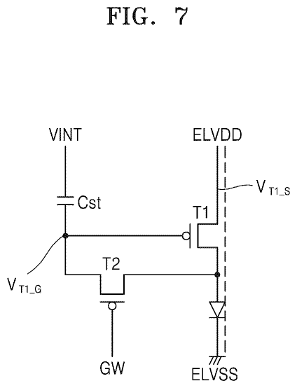

FIG. 7 is a circuit diagram for explaining the operation of the elements of the pixel PX of FIG. 2 in the light-emitting period.

Referring to FIG. 3, during the light-emitting period, the second driving voltage ELVSS applied to the cathode of the light-emitting element is a low-level voltage, the scan signal GW applied to the gate terminal of the second transistor T2 is a high-level voltage, the initialization voltage VINT applied to the second terminal of the storage capacitor Cst is a high-level voltage, and the voltage applied to the data/first driving voltage DATA/ELVDD line which is connected to a source terminal of the first transistor T1 is a first driving voltage ELVDD.

Based on these signals, referring to FIG. 7, the second transistor T2 is turned off, and the source terminal voltage V_{T1_S} of the first transistor T1 may have the first driving voltage ELVDD. In addition, when the initialization voltage VINT applied to the second terminal of the storage capacitor Cst is changed from a low level voltage to a high level voltage, the amount of change in the initialization voltage, that is, the difference (offset) between the high level voltage and the low level voltage of the initialization voltage, may be added to the gate terminal of the first transistor T1 (or the first terminal of the storage capacitor Cst) as a boosting voltage. Therefore, the gate terminal voltage V_{T1_G} of the first transistor T1 may be Vdata-Vth+ΔVINT. The voltage value when the initialization voltage VINT has a high level voltage may be set based on the voltage value when the initialization voltage (VINT) has a low level voltage and the offset value.

Meanwhile, when a low level second driving voltage ELVSS is applied to the cathode of the light-emitting element, current may flow through the source terminal of the first transistor T1, the drain terminal of the first transistor T1 (or the anode of the light-emitting element) and the cathode of the light-emitting element, and the light-emitting element may emit light through this current.

In summary, in the light-emitting period P4, the light-emitting element may emit light due to current flows through the light-emitting element LED.

Meanwhile, the voltage value when the second driving voltage ELVSS has a low level voltage may be appropriately set considering the characteristics of the light-emitting element. In some embodiments, the voltage value when the second driving voltage ELVSS has a low level voltage may be set to an optimized value to have the target brightness based on the characteristics of the light-emitting element LED.

Meanwhile, in an embodiment, a display device or display panel of the present disclosure including pixels PX according to embodiments of the present disclosure may have a sequential data writing and simultaneous light emission scheme. Specifically, in the display device or display panel of the present disclosure, a plurality of pixels PX may be simultaneously controlled in an initialization period P1, an on-bias period P3, and a light-emitting period P4, and sequentially controlled row by row in a data writing period P2.

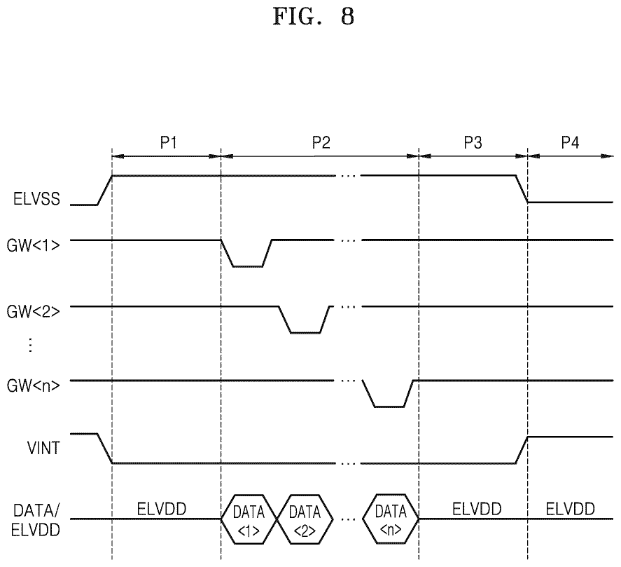

FIG. 8 is a timing diagram of signals for driving a display device according to an embodiment of the present disclosure.

The timing diagram illustrated in FIG. 8 may relate to a signal applied to n pixels PX connected to any one of a plurality of data lines DL.

As described above, multiple pixels PX may be controlled simultaneously in the initialization period P1. That is, even if a plurality of pixels PX are included in different rows, control in the initialization period P1 described above with reference to FIG. 4 may be performed simultaneously on multiple pixels PX.

As described above, a plurality of pixels PX may be sequentially controlled in the data writing period P2. That is, on each of the plurality of pixels PX, a data signal for the corresponding grayscale expression may be written based on the corresponding scan signals of scan signals GW<1>, GW<2>, . . . GW<n>.

As described above, a plurality of pixels PX may be controlled simultaneously in the on-bias period P3. That is, even if a plurality of pixels PX are included in different rows, control in the on-bias period P3 described above with reference to FIG. 6 may be performed simultaneously on a plurality of pixels PX.

As described above, a plurality of pixels PX may be controlled simultaneously in the light-emitting period P4. That is, even if multiple pixels PX are included in different rows, control in the light-emitting period P4 described above with reference to FIG. 7 may be performed simultaneously on a plurality of pixels PX.

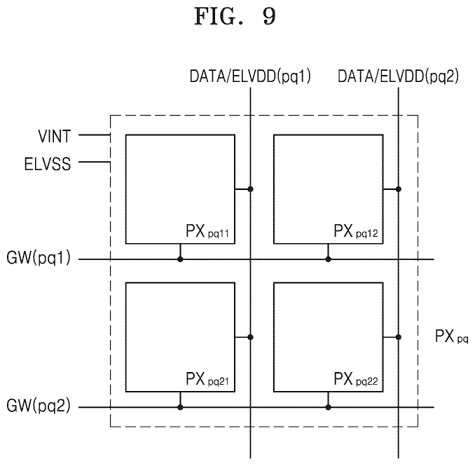

FIG. 9 is a circuit diagram for explaining a method of driving a sub-pixel (sub-PX) according to an embodiment of the present disclosure.

Depending on the design of the display device or display panel, one pixel may include a plurality of sub-pixels, and the plurality of sub-pixels may be controlled together by sharing some signals. The color of light emitted by the light-emitting elements included in each of the plurality of sub-pixels may be different or the same.

Although an example is described in FIG. 9 where one pixel PX includes four sub-pixels (sub-PX), the method according to the present disclosure may also be applied to a case where one pixel PX includes any number of sub-pixels (sub-PX).

Referring to FIG. 9, one pixel PX_{pq} among a plurality of pixels PX may include four sub-pixels PX_{pq11}, PX_{pq12}, PX_{pq21}, and PX_{pq22}.

In an embodiment, all four sub-pixels PX_{pq11}, PX_{pq12}, PX_{pq21}, and PX_{pq22} may share an initialization voltage VINT and a second driving voltage ELVSS. As described above, the pixel PX of the present disclosure may be applied with an initialization voltage VINT and a second driving voltage ELVSS whose amount of voltages change. In this embodiment, the pixel PX_{pq} is supplied with one initialization voltage VINT and one second driving voltage ELVSS, and may supply them to four sub-pixels PX_{pq11}, PX_{pq12}, PX_{pq21}, and PX_{pq22}.

Referring to FIG. 9, it is illustrated that an initialization voltage VINT and a second driving voltage ELVSS are applied to all four sub-pixels PX_{pq11}, PX_{pq12}, PX_{pq21}, and PX_{pq22} of a pixel PX_{pq}.

Meanwhile, in an embodiment, some of the four sub-pixels PX_{pq11}, PX_{pq12}, PX_{pq21}, and PX_{pq22} may be connected to one scan line, and some of the remaining sub-pixels may be connected to another scan line. In some embodiments, different scan lines may be connected to each row within a pixel PX_{pq}.

Referring to FIG. 9, it is illustrated that sub-pixel PX_{pq11} and sub-pixel PX_{pq12} are connected together to one scan line, and sub-pixel PX_{pq21} and sub-pixel PX_{pq22} are connected together to another scan line. Accordingly, the sub-pixel PX_{pq11} and the sub-pixel PX_{pq12} may be controlled by a scan signal GW(pq1) applied from one scan line, and the sub-pixel PX_{pq21} and the sub-pixel PX_{pq22} may be controlled by a scan signal GW(pq2) applied from another scan line.

Additionally, in an embodiment, some of the four sub-pixels PX_{pq11}, PX_{pq12}, PX_{pq21}, and PX_{pq22} may be connected to one data/first driving voltage line, and some of the remaining sub-pixels may be connected to another data/first driving voltage line. In some embodiments, different data/first driving voltage lines may be connected to each column within a pixel PX_{pq}.

Referring to FIG. 9, it is illustrated that the sub-pixel PX_{pq11} and the sub-pixel PX_{pq21} are connected together to one data/first driving voltage line, and the sub-pixel PX_{pq12} and the sub-pixel PX_{pq22} are connected together to another data/first driving voltage line. Accordingly, the sub-pixel PX_{pq11} and the sub-pixel PX_{pq21} may be controlled by data or a first driving voltage DATA/ELVDD(pq1) applied from one data/first driving voltage line, and the sub-pixel PX_{pq12} and the sub-pixel PX_{pq22} may be controlled by data or a first driving voltage DATA/ELVDD(pq2) applied from another data/first driving voltage line.

Meanwhile, the transistors included in the pixels according to various embodiments of the present disclosure as discussed above have been described based on P-type metal oxide semiconductor field effect transistor (MOSFET), but a design in which the transistors are changed to N-type MOSFET is also included in various embodiments described in the present disclosure, and such a change design will be easily understood by those skilled in the art.

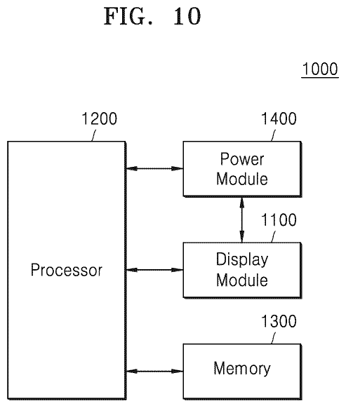

FIG. 10 depicts an electronic apparatus 1000 that includes a display module 1100, a processor 1200, a memory 1300, and a power module 1400. The electronic apparatus 1000 may further include a plurality of ports capable of communicating with a video card, a sound card, a memory card, a USB device, and the like, or communicating with other systems.

The display module 1100 may be the display panel or the display device 10 mentioned above.

The processor 1200 may perform specific calculations or tasks. According to an embodiment, the processor 1200 may be a microprocessor, a central processing unit (CPU), or the like. The processor 1200 may be connected to other components through an address bus, a control bus, a data bus, and the like. According to an embodiment, the processor 1200 may also be connected to an expansion bus such as a peripheral component interconnect (PCI) bus. The processor 1200 may control the display module 1100.

The processor 1200 may control the display module 1100. In an embodiment, the processor 1200 may distribute the image data and the controller signal that are provided to the control unit 17 of FIG. 1 to the display module 1100.

The memory 1300 may store data required for an operation of the electronic apparatus 1000. For example, the memory 1300 may include: a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device such as a dynamic random access memory (DRAM), a static random access memory (SRAM), or a mobile DRAM.

Each of the embodiments described above may be implemented independently, but the structure of each embodiment may be applied in combination to other embodiments.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

Specific implementations described in the embodiments are examples and do not limit the scope of the embodiments. In addition, if there is no specific mention such as “essential,” “important,”etc., it may not be a necessary component for the application of the disclosure.

The display device and the pixels disclosed herein may be used in various products such as portable electronic devices including mobile phones, smartphones, tablet personal computers (PCs), mobile communication terminals, electronic notebooks, e-books, portable multimedia players (PMPs), navigations, and ultra mobile PCs (UMPCs), and also televisions (TVs), laptops, monitors, billboards, Internet of Things (IoT), or the like. According to an embodiment, the display device and the pixels of this disclosure may also be used in wearable devices such as smart watches, watch phones, glasses-type displays, or head mounted displays (HMDs). According to an embodiment, the display device and pixels of this disclosure may also be used in dashboards of vehicles, center information displays (CIDs) of the center fascia or dashboards of vehicles, mirror displays that replace the side view mirrors of vehicles, and display screens arranged on the rear sides of front seats to serve as entertainment devices for back seat passengers of vehicles.

The use of the term “above” and similar referential terms in the specification of the embodiment (especially in the claims) may refer to both the singular and the plural. In addition, when a range is described in an embodiment, the disclosure includes the application of individual values within the range (unless there is a statement to the contrary), and is the same as describing each individual value constituting the range in the detailed description. Finally, unless the order of the operations constituting the method according to the embodiments is clearly stated or there is no description to the contrary, the operations may be performed in an appropriate order. The embodiments are not necessarily limited by the order of description of the operations above. The use of all examples or illustrative terms in the embodiments is simply for explaining the embodiments in detail, and the scope of the embodiments is not limited by the examples or illustrative terms unless limited by the claims. In addition, those skilled in the art will recognize that various modifications, combinations and changes may be made depending on design conditions and factors within the scope of the appended claims or their equivalents.

According to various embodiments of the present disclosure, pixels may be implemented with a smaller number of elements than conventional pixels, and a display device or display panel including such pixels may have a high degree of integration.

Each of the embodiments described above is an embodiment that may be implemented independently, but it goes without saying that the structure of each embodiment may be applied in combination to other embodiments.

Although the present disclosure has been described with reference to the embodiments shown in the drawings, these are merely exemplary, and those skilled in the art will understand that various modifications and equivalent other embodiments are possible therefrom. Therefore, the true technical protection scope of the present disclosure should be determined by the technical idea of the appended claims.

The specific implementations described in the embodiments are merely examples and do not limit the scope of the embodiments in any way. Additionally, if there is no specific mention such as “essential,” “importantly,” or the like, it may not be a component absolutely necessary for the application of the present disclosure.

The use of the term “the” and similar referential terms in the specification of embodiments (especially in the claims) may refer to both the singular and the plural. In addition, when a range is described in an embodiment, it is considered that the invention includes an individual value that falls within the range (unless otherwise stated), and it is the same as describing each individual value that constitutes the range in the detailed description. Finally, unless there is an explicit description of the order or sequence of steps constituting the method according to the embodiment, the steps may be performed in any suitable order. The embodiments are not necessarily limited to the order in which the steps are described. Any use of examples or exemplary terms in the embodiments is merely intended to elaborate the embodiments and is not intended to limit the scope of the embodiments, unless otherwise defined by the claims. Furthermore, those skilled in the art will appreciate that various modifications, combinations and variations may be made according to design conditions and factors within the scope of the appended claims or the equivalents thereof.

What is claimed is:

1. A pixel, comprising:
a first transistor a first terminal of which is connected to a first driving voltage line and a second terminal of which is connected to a second driving voltage line via a light-emitting element,
a second transistor connected between the second terminal of the first transistor and a gate terminal of the first transistor, and
a storage capacitor,
wherein one of a data signal and a first driving voltage is selectively supplied from the first driving voltage line.

2. The pixel of claim 1, wherein
a first terminal of the storage capacitor is connected to the gate terminal of the first transistor, and
a second terminal of the storage capacitor is connected to an initialization voltage line.

3. The pixel of claim 2, wherein an initialization voltage is supplied from the initialization voltage line and the initialization voltage swings between a high level voltage and a low level voltage.

4. The pixel of claim 1, wherein a cathode of the light-emitting element is connected to the second driving voltage line.

5. The pixel of claim 4, wherein a second driving voltage is supplied from the second driving voltage line and the second driving voltage swings between a high level voltage and a low level voltage.

6. The pixel of claim 1, wherein, in a data writing period, the data signal is applied to the first terminal of the first transistor.

7. The pixel of claim 6, wherein, in a period other than the data writing period, the first driving voltage is applied to the first terminal of the first transistor.

8. A display device, comprising:
a pixel unit including a plurality of pixels, each of the plurality of pixels is connected to a corresponding scan line among a plurality of scan lines and a corresponding data line among a plurality of data lines;
a scan driving unit that supplies scan signals to each of the plurality of pixels through the plurality of scan lines; and
a data driving unit that selectively supplies one of a data signal and a first driving voltage to each of the plurality of pixels through the plurality of data lines,
wherein each of the plurality of pixels comprises:
a first transistor a first terminal of which is connected to a first driving voltage line and a second terminal of which is connected to a second driving voltage line via a light-emitting element,
a second transistor connected between the second terminal of the first transistor and a gate terminal of the first transistor, and
a storage capacitor,
wherein one of a data signal and a first driving voltage is selectively supplied from the first driving voltage line.

9. The display device of claim 8, further comprising
a power supply unit that supplies an initialization voltage to each of the plurality of pixels through a plurality of initialization voltage lines,
wherein the first terminal of the storage capacitor is connected to the gate terminal of the first transistor and
the second terminal of the storage capacitor is connected to a corresponding initialization voltage line.

10. The display device of claim 9, wherein the initialization voltage swings between a high level voltage and a low level voltage.

11. The display device of claim 8, further comprising
a power supply unit that supplies an initialization voltage to each of the plurality of pixels through a plurality of second driving voltage lines,
wherein the cathode of the light-emitting element is connected to a corresponding second driving voltage line.

12. The display device of claim 11, wherein the second driving voltage swings between a high level voltage and a low level voltage.

13. The display device of claim 8, wherein each of the plurality data lines is connected to a first terminal of each of the first transistors of the plurality of pixels and the data driving unit supplies the data signal in the data writing period.

14. The display device of claim 13, wherein
the data driving unit supplies the first driving voltage in a period other than the data writing period.

15. An electronic device comprising:
a processor; and
a display device receiving a clock signal and image data from the processor, the electronic device including:
a first transistor a first terminal of which is connected to a first driving voltage line and a second terminal of which is connected to a second driving voltage line via a light-emitting element,
a second transistor connected between the second terminal of the first transistor and a gate terminal of the first transistor, and
a storage capacitor,
wherein one of a data signal and a first driving voltage is selectively supplied from the first driving voltage line.

16. The pixel of claim 15, wherein a first terminal of the storage capacitor is connected to the gate terminal of the first transistor and a second terminal of the storage capacitor is connected to an initialization voltage line.

17. The pixel of claim 16, wherein an initialization voltage is supplied from the initialization voltage line and the initialization voltage swings between a high level voltage and a low level voltage.

18. The pixel of claim 15, wherein a cathode of the light-emitting element is connected to the second driving voltage line supplying a second driving voltage which swings between a high level voltage and a low level voltage.

19. The pixel of claim 15, wherein, in a data writing period, the data signal is applied to the first terminal of the first transistor.

20. The pixel of claim 19, wherein, in a period other than the data writing period, the first driving voltage is applied to the first terminal of the first transistor.
